(19) United States
(12) Patent Application Publication
(10) Pub. No.: US 2019/0053439 A1
(43) Pub. Date: Feb. 21, 2019

(54) PLASTIC FILM FOR COVERNING LINEAR SOFT FRUIT CULTIVATIONS

(71) Applicant: Asterios DAIOS, Naoussa (GR)

(72) Inventor: Asterios DAIOS, Naoussa (GR)

(21) Appl. No.: 16/078,802

(22) PCT Filed: Feb. 25, 2016
(86) PCT No.: PCT/GR2016/000007

§ 371 Date: Aug. 22, 2018

(51) Int. Cl. A01G 13/02; F16B 5/12

(52) U.S. Cl. CPC A01G 13/0206; F16B 5/12

(57) ABSTRACT

The application refers to a plastic film for protecting linear soft fruit cultivations such as table grapes, raspberries, blueberries, blackberries, red currants, cherries etc. Soft fruit cultivation is commonly performed in a linear fashion so that any cultivation work can be facilitated. Soft fruits are susceptible to weather conditions especially when they are ripe enough for collection to start and in particular to hail, rain, humidity, and frost as well as the intense sun radiation that can cause skin burns to the fruit.

The invention refers to a plastic film for protecting linear soft fruit cultivations such as table grapes, raspberries, blueberries, blackberries, red currants, cherries etc.

Soft fruit cultivation is commonly performed in a linear fashion so that any cultivation work can be facilitated. Soft fruits are susceptible to weather conditions, especially when the are ripe enough for collection to start, and in particular to hail, rain, humidity and frost as well as the intense sun radiation that can cause skin burns to the fruit.

The present inventor as well as several inventors have proposed solutions for covering linear cultivations so that they can be protected from weather conditions. These solutions focus on using plastic films that cover the linear cultivations lengthways. The plastic films are usually produced employing materials such as polyolefins e.g. polyethylene, polypropylene, EVA, PVC or a blend thereof. The use of plastic films has been proven to provide a series of advantages such as protection of the crop from weather conditions, quality improvements, prolongation of the harvesting period and increase of the yields.

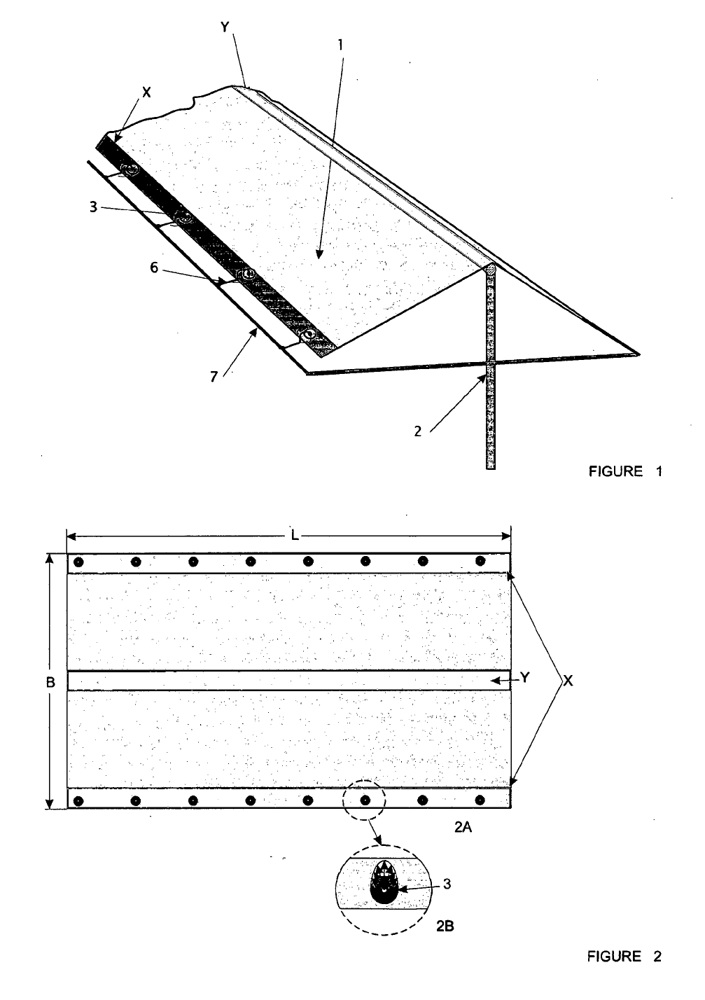

Putting these films in place on the cultivation lines is performed manually or by employing machines. For fixing the plastic films there is usually a supporting structure (FIG. 1) that consists of uprights (metallic, wooden or cement) that are fixed in the ground with a local foundation or anchoring. The uprights are placed along the axis of the cultivation line at equal distances—commonly every 5 m and they are also placed transversely in an array so that they form horizontal and perpendicular lines on the field. At a distance of ⅔ of every upright that is commonly above 2 m height from the ground so that cultivation works can be readily facilitated—the uprights are bridged among them both in transverse and longitudinal directions with wire ropes that provide stability to the supporting structure and function in parallel as positions where the plastic films can be bound. Furthermore, the top sections of the uprights are bridged lengthways with wire ropes doubling as supports for the plastic film weight.

The plastic film is placed on the supporting structure and is bound on the wire ropes with ropes/strings or elastic straps or in other fashions such as the solutions that the present inventor proposed with the patents GR1002871 and GR1003863.

To fix the film in place holes are punched or cut on the film at the field along both sides lengthways as also described in U.S. Pat. No. 6,813,859 BI, or there are predetermined metallic or plastic binding positions/eyelets at specified distances and commonly at a distance 25-100 cm from one eyelet to the next. The sections of the film where holes are cut or punched or where predetermined eyelets are placed are reinforced in terms of material thickness so that the film exhibits enhanced mechanical properties.

The reinforcement lengthways at both sides of the film and its mid section (FIGS. 1X and Y) is achieved by either producing the film with varying thickness across its width or by welding or sewing additional stripes of plastic film or weave along both sides as well as the mid section lengthways, or lastly by extruding or laminating the film at these predetermined sections. Other solutions involve incorporating a rope/string at both sides of the plastic films lengthways as for example described in patent ITBA20130077 or with welding a preform that incorporates the plastic cord/string that is welded or extruded along both sides of the plastic film so that the needed reinforcement is achieved.

It is of paramount importance to note here that during extrusion of the plastic film, the mechanical properties vary considerably between the longitudinal (machine) and transverse directions as the production process leads to better mechanical properties in the longitudinal direction. However, the forces exerted on the binding positions are concentrated locally around the holes and are gradually dissipated as we move towards the mid lengthways axis of the film.

Any of the aforementioned solutions exhibits disadvantages that the current invention resolves. Plastic films on which holes are cut or punched exhibit fast wearing, as the positions where the film is bound are not sufficiently reinforced so that they can withstand the loading especially in case of windy weather conditions. As a result, they get easily damaged and have a short life span. In the case of plastic films that are reinforced at the sides and bear metallic or plastic eyelets the localised force concentration is clearly more evenly distributed around the eyelets spreading the loading on both longitudinal and transverse directions however that only happens around the eyelets and not all along the film leading to a need for heavier/thicker films in order for the eyelets to withstand the loading.

Solutions that employ cords have the disadvantage that the cord (incorporated, welded or extruded) reinforces only the longitudinal direction hence the machine direction while the loading on the film is mainly applied in the transverse direction namely the direction that is weaker between the two. Consequently, such films are easily torn and damaged particularly at the position right after the cord and very near to it, as the transverse direction is not reinforced at all although it is the direction that bears the loading from the cords or elastic bands that bind the plastic film to the supporting structure.

Hence there is a need to produce a plastic film for covering linear soft fruit cultivations that will distribute the exerted loading from the ropes/cords or elastic straps that tie the plastic film to the supporting structure to both the longitudinal as well as the transverse directions in such a fashion so that the forces are distributed along the whole length of the plastic film providing more strength and the possibility to considerably reduce the thickness hence the cost of the plastic film alongside the life span of the product. Hence it leads to a considerable cost reduction for the soft fruit grower both in terms of acquiring the film, replacing it as well as a considerable ease of use as the reduced thickness allows for easier handling when installing and removing the film at the field at the beginning and the end of every season. This is achieved by incorporating in any manner a plastic cord along both longitudinal sides of the film that would allow the distribution of the loads in both longitudinal and transverse directions in other words that it will be either an inclined line in relation to the main lengthways axis or a waveform that could be for example described by the equation f(x)=α*sin x of any period and respective amplitude. This is achieved as the loading is distributed along the inclined line or waveform hence changing direction along it and as a result the force components are distributed in both directions all along both longitudinal sides.

Below the invention is described in the respective schematics:

FIG. 1: A conventional plastic film (1) placed above the cultivation line. Depicted are the reinforced sections (X) and (Y), the eyelets (3), the ropes/strings/elastic bands (6), the supporting structure (2), the wire ropes (7) that bind the plastic film to the supporting structure

FIGS. 2A and 2B: Plastic film (1) with eyelets (3), (metallic or plastic), reinforced sections (X) and (Y) and a detail of the load distribution around an individual eyelet (2B).

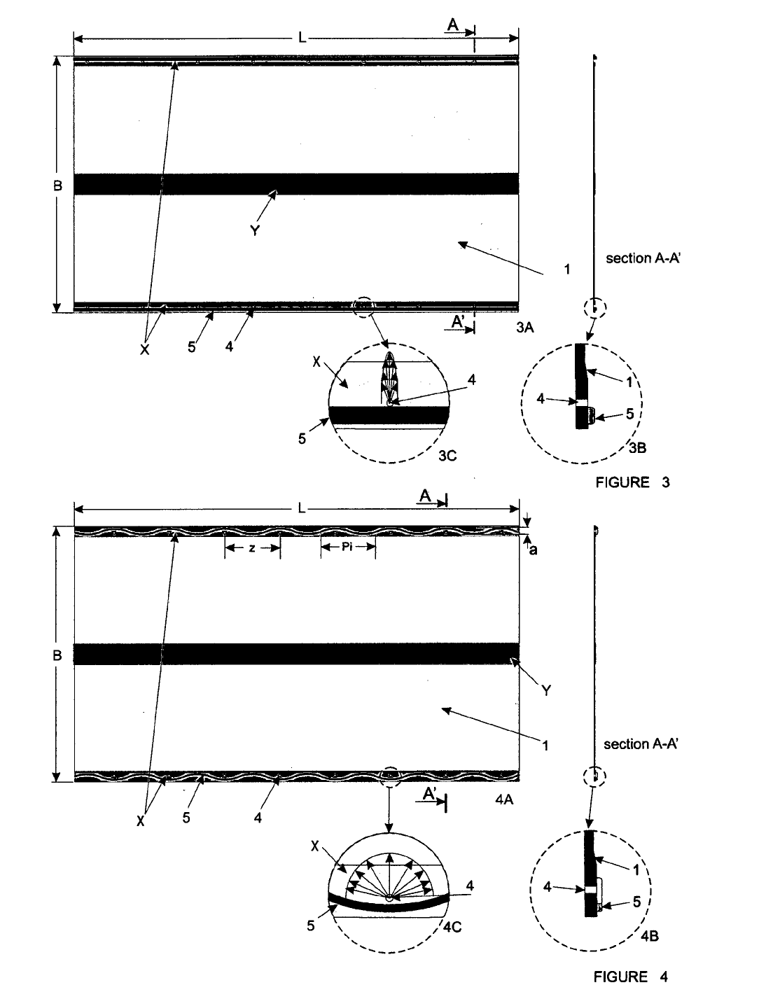

FIGS. 3A, 3B and 3C: Plastic film (1) with an incorporated cord (5), glued, welded, or extruded on the plastic film along both its lengthways sides, the reinforced sections (X), the cut or punched holes (4). And a detail of the load distribution close to the binding position. Depicted is also the cross section of the film (section A-A′) (38) showing the cross sectional geometry of the plastic cord. FIG. 3C depicts the load distribution at the hole (4)

FIGS. 4A, 4B and 4C: Plastic film (1) with a waveform cord (5) that is glued, welded or extruded on the plastic film (1) along both its lengthways sides, reinforced sections (X), the holes (4) (4A) and a detail of the force distribution near the binding position (4B). Depicted is also the cross section of the film (section A-A′) (4B). Figure (4C) depicts the wider load distribution of the waveform plastic cord

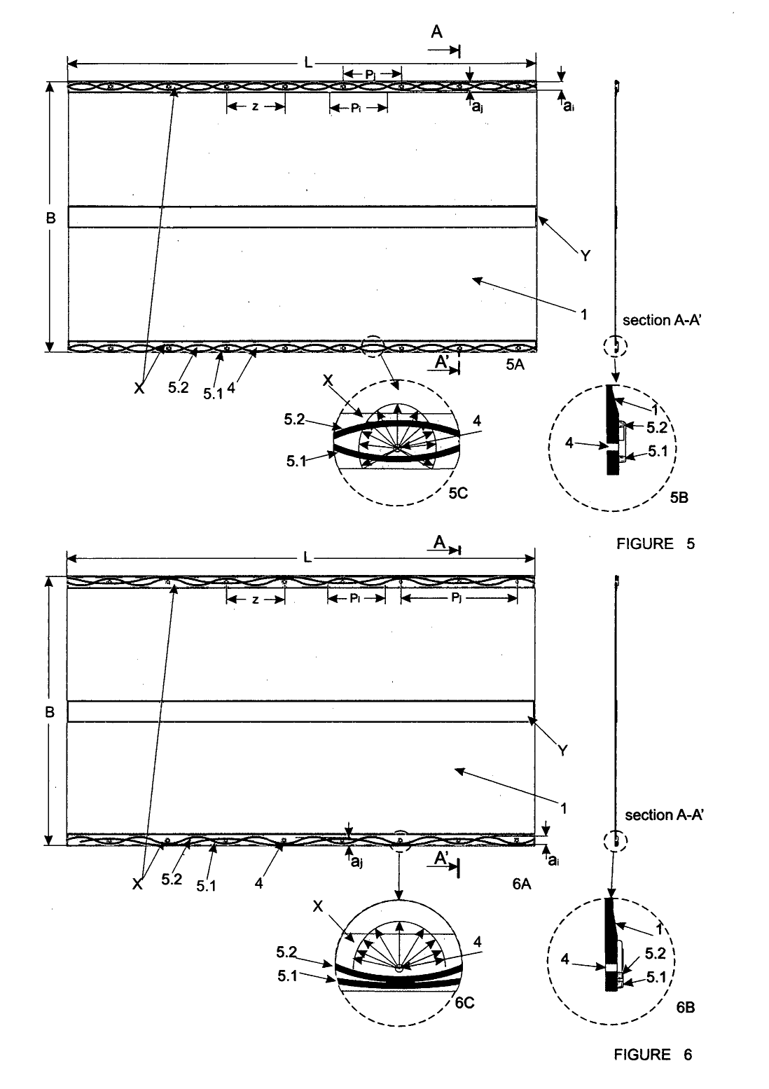

FIG. 5: Plastic film (1) for covering linear soft fruit cultivations that bears two plastic waveform cords (5.1 and 5.2) on both its lengthways sides that have between them the same or different period and/or amplitude. Depicted are also the reinforced sections (X and Y) and the holes (4) as well as cross sections of the film (section A-A′) (5B). Figure (5C) depicts the load distribution around antisymmetric waveform plastic cords.

FIG. 6: Plastic film (1) for covering linear soft fruit cultivations that bears two waveform plastic cords (5.1 and 5.2) on both its lengthways sides that have between them different periods and/or different amplitudes. Depicted are also the reinforced sections (X and Y) and the holes (4) as well as cross section of the film (section A-A′) with the load distribution.

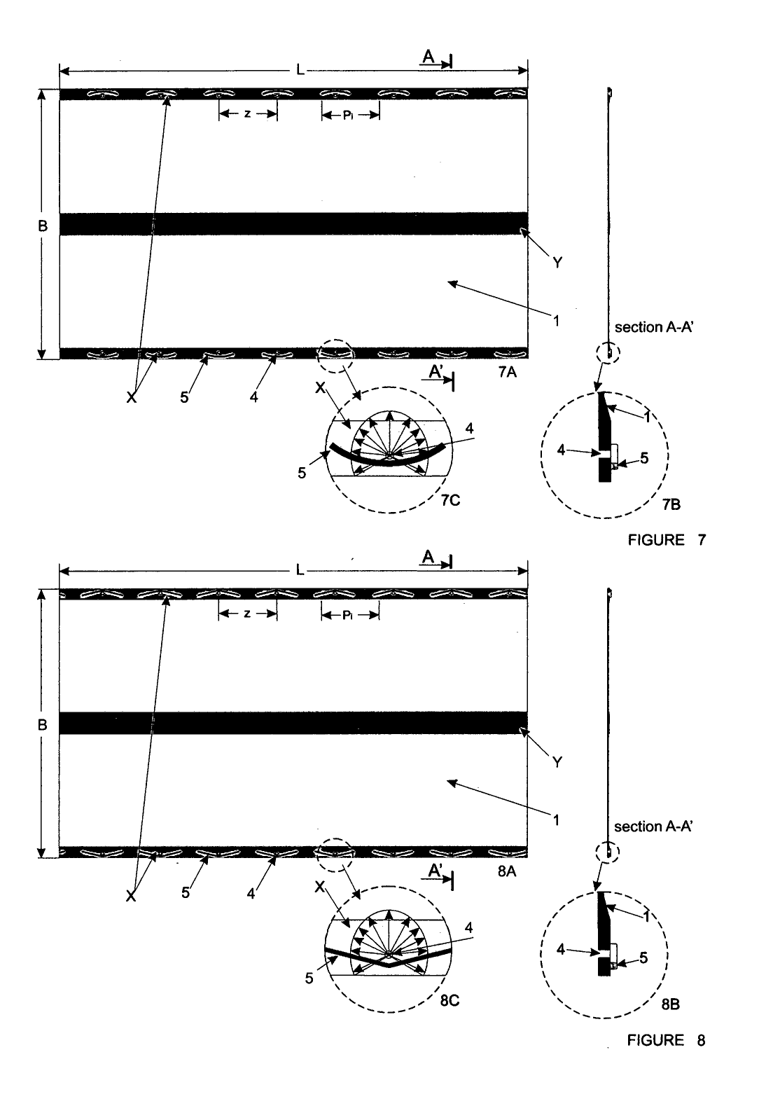

FIG. 7: Plastic film (1) for covering linear soft fruit cultivations that bears plastic cord (5) or cords that have the form of a discontinuous waveform curve. Depicted are also the reinforced sections (X and Y) and the holes (4) as well as cross section of the film (section A-A′) with the load distribution

FIG. 8: Plastic film (1) for covering linear soft fruit cultivations that bears plastic cord (5) or cords that have the form of a discontinuous inclined linear line. Depicted are also the reinforced sections (X and Y) and the holes (4) as well as cross section of the film (section A-A′) with the load distribution

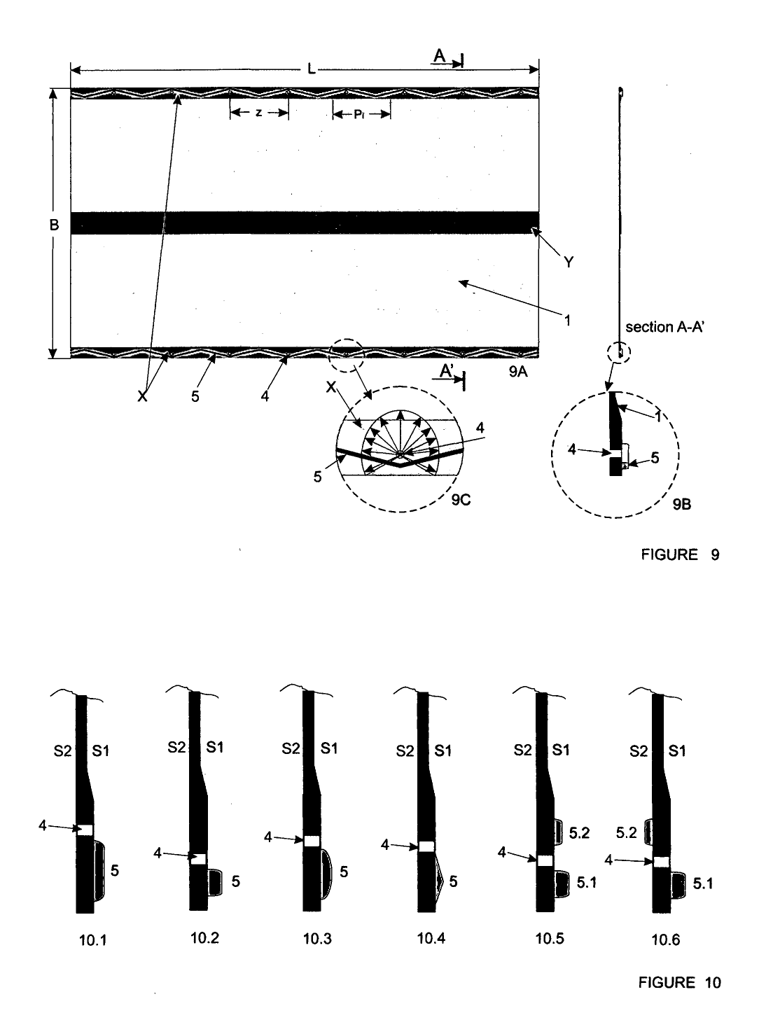

FIG. 9: Plastic film (1) for covering linear soft fruit cultivations that bears a plastic cord that is inclined in relation to the main lengthways axis and follows a zig zag pattern. Depicted are also the reinforced sections (X and Y) and the holes (4) as well as cross section of the film (section A-A′) with the load distribution

FIG. 10: Depicts in cross sectional view one of the two longitudinal reinforced areas (X) that bears plastic cord (5) or cords (5.1 and 5.2) that can have a cross-sectional footprint of any shape and can be located on one (S1) (FIG. 10.1 to 10.5) or both surfaces (S1 and S2) of the film (FIG. 10.6).

According to the first embodiment of the invention (FIG. 4) a plastic film (1) is produced by employing a polyolefin such as LDPE, LLDPE, EVA etc. or a combination thereof. The plastic film can have any length (L) and width (B) that can be produced in any manner such as blown or cast film extrusion as monolayer or multilayer incorporating any additives so that it could exhibit any thermal, optical and mechanical properties. The plastic film that is produced in such a fashion so that it has varying thickness across its width and in particular thicker at a section (X) at both its lengthways edges as well as at a stripe (Y) along the mid longitudinal axis of the plastic film. Alternatively, the reinforced areas (X) and (Y) can be produced by either gluing, welding or sewing additional plastic film stripes or weaves of the same or different material or by folding the two edges and welding the two surfaces at the whole width (X) and additionally gluing, welding, sewing a stripe at the section (Y). Lastly the reinforcement could be achieved by directly extruding or laminating additional material on the plastic film at sections (X) and (Y). On both reinforced sections lengthways of the plastic film (X) a plastic cord is glued, welded or extruded employing the same material as the plastic film or different to it that is a waveform curve that has any period (Pᵢ) and amplitude (a)<(X) and preferably period 50 cm and amplitude 15 cm. Holes (4) are then cut or punched on the film at the troughs of the waveform curve having a diameter (D) and being placed very near to the plastic cord so that a rope or elastic band can be used to tie the film to the supporting structure. The period of the holes (z) can be the same as the period of the waveform curve or different and a multiple of it.

According to the second embodiment the invention (FIG. 5) the plastic film is produced in such a fashion so that it has varying thickness across its width and in particular thicker at a section (X) at both its lengthways edges as well as at a stripe (Y along the mid longitudinal axis of the plastic film. Alternatively, the reinforced areas (X) and (Y) can be produced by either gluing, welding or sewing additional plastic film stripes or weaves of the same or different material or by folding the two edges and welding the two surfaces at the whole width (X) and additionally gluing, welding, sewing a stripe at the section (Y). Lastly the reinforcement could be achieved by directly extruding or laminating additional material on the plastic film at sections (X) and (Y). On both lengthways reinforced sides (X) several and preferably two plastic cords (5.1 and 5.2) are glued, welded or extruded on the film employing the same material as the plastic film or any material different to it, having the form of a waveform curve with periods (Pᵢ) and (Pⱼ) and amplitudes (aᵢ) and (aⱼ) and preferably the two plastic cords are antisymmetric that can be for example described by the equations f(x)=α*sin x and f(x)=−α*sin x respectively. Holes (4) are then cut or punched on the film at the troughs of the waveform curve having a diameter (D) and being placed very near to the troughs of the plastic cords so that a rope or elastic band can be used to tie the film to the supporting structure. The period of the holes (z) can be the same as the period of the waveform curves or different and a multiple of it.

According to the third embodiment of the invention the plastic film is produced in such a fashion so that it has varying thickness across its width and in particular thicker at a section (X) at both its lengthways edges as well as at a stripe (Y) along the mid longitudinal axis of the plastic film. Alternatively, the reinforced areas (X) and (Y) can be produced by either gluing, welding or sewing additional plastic film stripes or weaves of the same or different material or by folding the two edges and welding the two surfaces at the whole width (X) and additionally gluing, welding, sewing a stripe at the section (Y). Lastly the reinforcement could be achieved by directly extruding or laminating additional material on the plastic film at sections (X) and (Y). The plastic cords could be glued, welded or extruded on both surfaces of the film. In addition, the plastic cords that are described by equations such as f(x)=α*sin x and f(x)=−α*sin x could be placed for example cord (5.1) on surface (S1) and cord (5.2) on surface (S2) or vice versa (FIG. 10). Holes (4) are then cut or punched on the film at the troughs of the waveform curve having a diameter (D) and being placed very near to the troughs of the plastic cords so that a rope or elastic band can be used to tie the film to the supporting structure. The period of the holes (z) can be the same as the period of the waveform curves or different and a multiple of it.

According to the fourth embodiment of the invention the plastic film is produced in such a fashion so that it has varying thickness across its width and in particular thicker at a section (X) at both its lengthways edges as well as at a stripe (Y) along the mid longitudinal axis of the plastic film. Alternatively, the reinforced areas (X) and (Y) can be produced by either gluing, welding or sewing additional plastic film stripes or weaves of the same or different material or by folding the two edges and welding the two surfaces at the whole width (X) and additionally gluing, welding, sewing a stripe at the section (Y). Lastly the reinforcement could be achieved by directly extruding or laminating additional material on the plastic film at sections (X) and (Y). The plastic cord or one of the plastic cords or all of the plastics cords could be glued, welded or extruded on one or one both surfaces of the film as modulated waveforms namely a combination of waveforms with periods (Pᵢ, Pⱼ, Pₖ . . . ) and amplitudes (aᵢ, aⱼ, aₖ, . . . ). Holes (4) are then cut or punched on the film at the troughs of the waveform curve having a diameter (D) and being placed very near to the troughs of the plastic cords so that a rope or elastic band can be used to tie the film to the supporting structure. The period of the holes (z) can be the same as the period of the waveform curves or different and a multiple of it.

According to the fifth less preferable embodiment of the invention the plastic film is produced in such a fashion so that it has varying thickness across its width and in particular thicker at a section (X) at both its lengthways edges as well as at a stripe (Y) along the mid longitudinal axis of the plastic film. Alternatively, the reinforced areas (X) and (Y) can be produced by either gluing, welding or sewing additional plastic film stripes or weaves of the same or different material or by folding the two edges and welding the two surfaces at the whole width (X) and additionally gluing, welding, sewing a stripe at the section (Y). Lastly the reinforcement could be achieved by directly extruding or laminating additional material on the plastic film at sections (X) and (Y). The plastic cord or plastic cords are comprised of several inclined linear lines of the same or different inclinations in relation to the main lengthways axis that follow instead of a waveform a zig zag pattern (FIG. 9) that is either continuous or intermittent.

It is also important to note that in case there are several plastic cords on each lengthways sides they could have different periods (Pᵢ) and amplitudes (aᵢ) among them as well as along the lengthways side. They could for example in the case of having two cords on each side be described by different equations such as f(x)=α*sin x and f(x)=−β*sin(x/2). Lastly there could be different periods and amplitudes among all plastic cords on the plastic film.

Furthermore, there could be discontinuous inclined lines in relation to the main lengthways axis or waveform plastic cords applied on the film namely applied on selected sections along the lengthways sides of the plastic film and not to its entire length (FIGS. 7 & 8)

The geometry of the cross-section of the plastic cord could be circular, semi circular, trapezoid, square, rectangular, elliptical as well as of variable geometry along the length of the film (FIG. 10). In cases where there are more than one plastic cords they could be of different cross sectional geometry as well.

In addition, the material employed to produced the plastic cord could have additives such as glass fibres and/or elastomers so that it exhibits exceptional mechanical properties.

I claim:

1. Plastic film for covering linear soft fruit cultivations that bears reinforced sections in terms of thickness (X) along both edges as well as a reinforced section (Y) along a mid-section lengthways, said reinforcement produced by extruding the film with variable thickness across the width or by gluing, welding, sewing additional stripes of the same or different material or by directly extruding or laminating additional material on sections (X) and (Y) or by folding the lengthways edges and welding the fold on the plastic film at the whole section (X) and reinforcing section (Y) separately that is characterised by fact that a plastic cord is glued, welded or extruded along both lengthways sides being partially or entirely inclined in relation to the main lengthways axis with said inclination being constant or changing direction and following a repetitive pattern with period Pᵢ and bearing holes at both sections (X), adjacent to the inclined cord and at the positions that are closer to the edge however towards the side of the cord that is facing the main lengthways axis of the plastic film; said cord has a diameter (D) less than 10 mm and due to said inclination of the cord, the cord distributes the exerted load at the whole reinforced area of the plastic film in both longitudinal and traverse directions, thus increasing the strength of the plastic film.

2. Plastic film for covering linear soft fruit cultivations according to claim 1 that is characterised by the fact that the inclined cord has the form of a waveform curve with period (Pᵢ) and amplitude (aᵢ).

3. Plastic film for covering linear soft fruit cultivations according to claim 1 that is characterised by the fact that on every lengthways edge the plastic films bears several plastic cords that are glued, welded or extruded and are placed on the same surface or on both surfaces of the plastic film and are described by a symmetrical waveform curve f(x)=a*sin x καl f(x)=−a*sin x.

4. Plastic film for covering linear soft fruit cultivations according to claim 1 that is characterised by the fact that on every lengthways edge the plastic films bears several plastic cords that are glued, welded or extruded and are placed on the same surface or on both surfaces of the plastic film and have different periods (Pᵢ) and amplitudes (aᵢ) among them.

5. Plastic film for covering linear soft fruit cultivations according to claim 1 that is characterised by the fact that the cross section of the plastic cord employed can be of any shape and/or of variable geometry along the length of the film.

6. Plastic film for covering linear soft fruit cultivations according to claim 1 that is characterised by the fact that the plastic cord or cords are discontinuous as to the lengthways axis of the plastic film and exhibit a repetitive pattern.

7. Plastic film for covering linear soft fruit cultivations according to claim 1 that is characterised by the fact that the plastic cord or plastic cords are inclined in relation to main lengthways axis of the plastic film and form a repetitive pattern with period Pᵢ either having the same inclination or different inclinations intersecting each other or not thus forming a continuous or discontinuous zig zag form.
